(19) United States
(12) Patent Application Publication
(10) Pub. No.: US 2023/0196437 A1
(43) Pub. Date: Jun. 22, 2023

(54) SYSTEM AND METHOD FOR REVIEW BASED ONLINE PRODUCT RECOMMENDATION

(71) Applicant: Myntra Designs Private Limited, Bangalore (IN)

(72) Inventors: Lakshya Kumar, Ghaziabad (IN); Sreekanth Vempati, Hyderabad (IN); Konduru Saiswaroop, Wanaparthy (IN); Sangeet Jaiswal, Gurgaon (IN)

(21) Appl. No.: 17/695,413

(22) Filed: Mar. 15, 2022

(30) Foreign Application Priority Data
Dec. 22, 2021 (IN) 202141059933

(51) Int. Cl. G06Q 30/06

(52) U.S. Cl. CPC G06Q 30/0631; G06Q 30/0627; G06Q 30/0643

(57) ABSTRACT

A system and method for generating product recommendations for a customer in an e-commerce retail environment is presented. The system includes a data module configured to extract one or more information for one or more products purchased via the e-commerce retail environment, a first attribute extraction module configured to extract one or more product attributes of interest to the customer and a corresponding sentiment, a product identification module configured to identify one or more products similar to a product of interest, a second attribute extraction module configured to extract one or more similar product attributes and a corresponding sentiment, an attribute comparison module configured to compare the one or more product attributes of interest and the corresponding sentiment with the one or more similar product attributes and the corresponding sentiment, and identify a product for recommendation, and a product recommender configured to recommend to the customer the identified product.

### PRIORITY STATEMENT

The present application hereby claims priority to Indian patent application number 202141059933 filed on 22 Dec. 2021, the entire contents of which are hereby incorporated herein by reference.

### BACKGROUND

Embodiments of the present invention generally relate to systems and methods for generating product recommendations for a customer in an e-commerce retail environment, and more particularly to systems and methods for generating reviews-based product recommendations for a customer in an e-commerce retail environment.

Online shopping (e-commerce) platforms for fashion items, supported in a contemporary Internet environment, are well known. Shopping for clothing items online via the Internet is growing in popularity because it potentially offers shoppers a broader range of choices of clothing in comparison to earlier off-line boutiques and superstores. Currently, shopping on e-commerce platforms is determined by the customer's search for a particular product and/or browsing of product catalogs on the e-commerce platform. It may be desirable to provide product recommendations to a customer that are customer-specific and are relevant to the customer.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for generating product recommendations for a customer in an e-commerce retail environment is presented. The system includes a data module configured to extract one or more information for one or more products purchased via the e-commerce retail environment. The system further includes a first attribute extraction module configured to extract, based on the one or more information, one or more product attributes of interest to the customer and a corresponding sentiment. The system moreover includes a product identification module configured to identify one or more products similar to a product of interest; and a second attribute extraction module configured to extract, based on one or more product reviews for the similar products, one or more similar product attributes and a corresponding sentiment. The system further includes an attribute comparison module configured to compare the one or more product attributes of interest and the corresponding sentiment with the one or more similar product attributes and the corresponding sentiment, and identify at least one product for recommendation from the one or more similar products based on the comparison. The system furthermore includes a product recommender configured to recommend to the customer the at least one identified product.

According to another example embodiment, a method for generating product recommendations for a customer in an e-commerce retail environment is presented. The method includes extracting one or more information for one or more products purchased via the e-commerce retail environment; and extracting, based on the one or more information, one or more product attributes of interest to the customer and a corresponding sentiment. The method further includes identifying one or more products similar to a product of interest; and extracting, based on one or more product reviews for the similar products, one or more similar product attributes and a corresponding sentiment. The method moreover includes comparing the one or more product attributes of interest and the corresponding sentiment with the one or more similar product attributes and the corresponding sentiment, and identifying at least one product for recommendation from the one or more similar products based on the comparison. The method furthermore includes recommending the at least one identified product to the customer.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example system for product recommendations, according to some aspects of the present description,

FIG. 2 illustrates an example scenario for review-based product recommendation, according to some aspects of the present description,

FIG. 3 illustrates an example scenario for review-based product recommendation, according to some aspects of the present description,

FIG. 4 illustrates an example scenario for review-based product recommendation, according to some aspects of the present description,

FIG. 5 illustrates an example scenario for review-based product recommendation, according to some aspects of the present description,

FIG. 6 illustrates a flow chart for product recommendations, according to some aspects of the present description, and

FIG. 7 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for generating product recommendations for a customer in an e-commerce retail environment. Some embodiments of the present description provide systems and methods for generating product recommendations for a customer in an e-commerce retail environment based on product reviews.

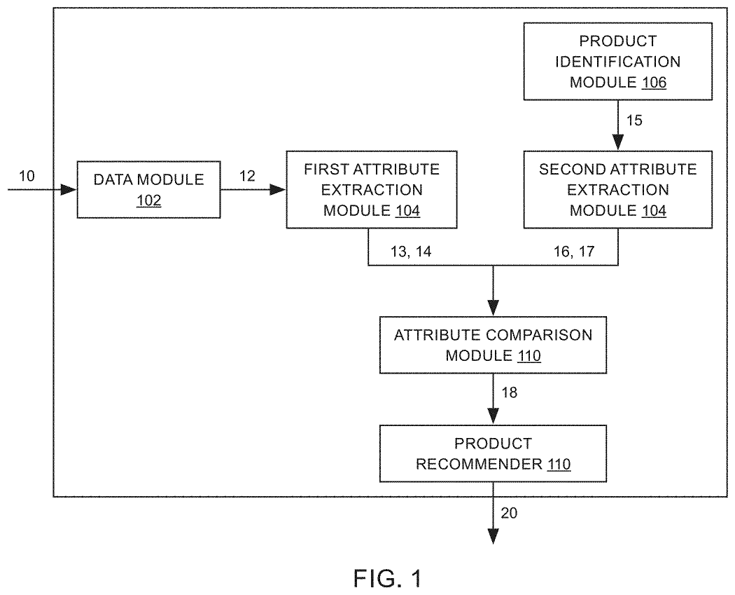

FIG. 1 illustrates an example system 100 for generating product recommendations for a customer in an e-commerce retail environment. The product may be selected from fashion products, electronic products, household items, furniture items, decorative items, linen, furnishing (carpets, cushions, curtains), lamps, tableware, and the like. In one embodiment, the product is a fashion product. Non-limiting examples of fashion products include garments (such as top wear, bottom wear, and the like), accessories (such as scarves, belts, socks, sunglasses, bags), jewelry, footwear and the like. For the purpose of this description, the following embodiments are described with respect to an online fashion retail platform. However, it must be understood that embodiments described herein can be implemented on any e-commerce platform having a portfolio of retail items/products.

The system 100 includes a data module 102, a first attribute extraction module 104, a product identification module 106, a second attribute extraction module 106, an attribute comparison module 108, and a product recommender 108. Each of these components is described in detail below.

The data module 104 is configured to extract one or more information 12 for one or more products 10 purchased via the e-commerce retail environment. In some embodiments, the one or more products 10 are products purchased via the e-commerce retail environment by the customer for whom the recommendation is being generated. In some embodiments, the one or more products 10 are products purchased via the e-commerce retail environment by a customer different from the customer for whom the recommendation is being generated. The one or more products 10 may belong to the same product categories, styles, or brands, or may belong to different product categories, styles, or brands as the product for which the recommendation is being generated.

The one or more information 12 includes one or more product reviews for one or more products purchased via the e-commerce retail environment by the customer, one or more upvotes or downvotes submitted by the customer for product reviews on the e-commerce retail environment, one or more interactions with a product or with corresponding attributes by the customer on the e-commerce retail environment, or combinations thereof.

In one embodiment, the one or more information 12 includes one or more product reviews for one or more products purchased via the e-commerce retail environment by the customer. In such embodiments, the data module 102 may be configured to extract the one or more product reviews based on historical purchase data of the customer. The one or more product reviews may belong to the same product categories, styles, or brands, or may belong to different product categories, styles, or brands as the product for which the recommendation is being generated.

In some embodiments, the customer may be new to the e-commerce retail environment or may not have submitted any reviews for products purchased via the e-commerce retail environment. In some such embodiments, the one or more information 12 may include one or more interactions with a product or with corresponding attributes by the customer in the e-commerce retail environment. For example, the customer may have clicked one or more attributes of interest for a particular product on the e-commerce retail environment, may have searched for a particular attribute and/or a product on the e-commerce retail environment, or may have selected attributes of interest for a product from a selection criterion.

Further, in some such embodiments, the one or more information 12 may include one or more upvotes or downvotes submitted by the customer for product reviews submitted by another customer on the e-commerce retail environment. In such embodiments, the data module 102 may be configured to extract the one or more information 12 corresponding to the product and/or attribute interactions by the customer or upvotes/downvotes submitted by the customer on the e-commerce retail environment.

Furthermore, in some such embodiments, the one or more information 12 may include one or more product reviews submitted by another customer having a similar purchase profile as the current customer or by another customer having a similar geo-location as the current customer. The purchase profile of the customers may be generated based on browsed products, products added to cart, purchase history, and the like. In such embodiments, the data module 102 may be configured to extract the one or more information 12 from one or more products 10 purchased via the e-commerce retail environment by a customer different from the customer for whom the recommendation is being generated.

The data module 102 is communicatively coupled to a first attribute extraction module 104 as shown in FIG. 1. The first attribute extraction module 104 is configured to extract, based on the one or more information, one or more product attributes of interest 13 to the customer and a corresponding sentiment 14. The term “product attributes of interest” as used herein refers to attributes of a product that are of interest to the customer for whom the recommendation is being generated. By way of example, for a garment, the product attributes of interest may include, for example, color, material, size, fit, style, and the like. Similarly, for an electronic product, the product attributes of interest may include, for example, processing performance, battery life, water durability, and the like. The sentiment may correspond to positive or negative sentiment. Or, alternately may have further sub-classifications such as strongly positive, somewhat positive, and the like.

The products attributes of interest may be extracted by the first attribute extraction module from one or more product reviews for one or more products purchased via the e-commerce retail environment by the customer, from one or more upvotes or downvotes submitted by the customer for product reviews on the e-commerce retail environment, from one or more interactions with a product or with corresponding attributes by the customer on the e-commerce retail environment, or from combinations thereof.

The first attribute extraction module 104 is configured to extract the one or more product attributes of interest to the customer 13 and a corresponding sentiment 14 using machine learning models. Non-limiting examples of suitable machine learning models include transformer variants, long short-term memory (LSTM) models, and the like. The first attribute extraction module 104 is further configured to store the product information along with the extracted attributes of interest and corresponding sentiment.

The system 100 further includes a product identification module 106 configured to identify one or more products 15 similar to a product of interest. The term “product of interest” as used herein refers to a product for which the recommendation is being generated. The product of interest may be determined based on the one or more information extracted by the data module 102, in some embodiments. For example, if the data module 102 extracts product reviews corresponding to a top-wear, the product identification module 106 may further identify the “product of interest” as a “top wear” and identify one or more similar products 15 corresponding to a “top wear”. In some other embodiments, the product of interest may be determined based on a current search for a product by the customer, or, alternatively, previous search history, browsing history, product wish list added by the customer on the e-commerce retail environment. For example, if the customer has searched for a watch on the e-commerce retail environment, the product identification module 106 may further identify the “product of interest” as a “watch” and identify one or more similar products 15 corresponding to a “watch”.

The product identification module 106 is configured to identify the one or more similar products 15 based on the one or more product attributes of interest and/or an image of the product of interest. In some embodiments, the product identification module 106 is configured to identify the one or more similar products 15 based on low-dimensional representations of the products derived using a deep learning model corresponding to one or more products of interest.

The product identification module 106 is configured to identify one or more similar products belonging to the same category as the product of interest or from a different category as the product of interest. The product identification module 106 may be further configured to extract one or more product reviews for the identified similar products. The product identification module 106 is communicatively coupled to a second attribute extraction module 108. The second attribute extraction module 108 is configured to extract, based on one or more product reviews for the similar products, one or more similar product attributes 16 and a corresponding sentiment 17. The term “similar product attributes” as used herein refers to product attributes extracted from products identified as similar by the product identification module 106 to the product of interest.

The second attribute extraction module 108 is configured to extract the one or more similar product attributes 16 and a corresponding sentiment 17 using machine learning models. Non-limiting examples of suitable machine learning models include transformer variants, long short-term memory (LSTM) models, and the like. The second attribute extraction module 108 is further configured to store the product information along with the extracted similar product attributes 16 and corresponding sentiment 17.

The system 100 further includes an attribute comparison module 110 communicatively coupled with the first attribute extraction module 106 and the second attribute extraction module 108. The attribute comparison module 110 is configured to compare the one or more product attributes of interest 13 and the corresponding sentiment 14 with the one or more similar product attributes 16 and the corresponding sentiment 17. The attribute comparison module 110 is further configured to identify at least one product for recommendation from the one or more similar products based on the comparison.

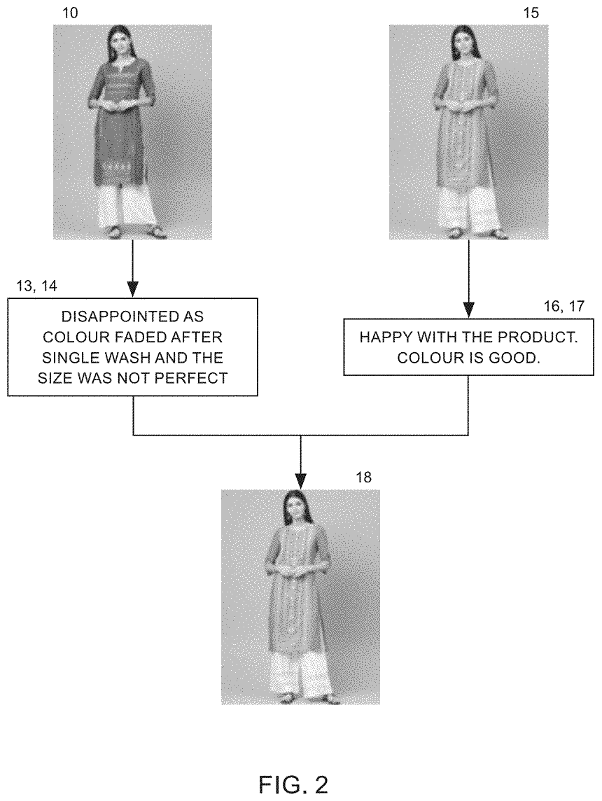

FIG. 2 illustrates an example scenario for identifying a product for recommendation by comparing the one or more product attributes of interest 13 and the corresponding sentiment 14 with the one or more similar product attributes 16 and the corresponding sentiment 17. In the example illustrated in FIG. 2, the data module is configured to extract a product review submitted by a customer for a top-wear 10. The first attribute extraction module 104 is further configured to extract attributes of interest 13 and a corresponding sentiment 14. For example, in FIG. 2, the attributes of interest 13 are “colour” and “size”. Further, the sentiment corresponding to the attributes of interest 13 is negative as shown in FIG. 2. The product identifier 106 is configured to identify a top-wear 15 similar to the top-wear 10 and further configured to extract product reviews for the top-wear. The second attribute extraction module 108 is configured to extract similar product attributes 16 and a corresponding sentiment 17. For example, in FIG. 2, the similar product attribute 16 is “colour” and the corresponding sentiment 17 is positive. In the embodiment illustrated in FIG. 2, the attribute comparison module 110 is configured to compare the attributes of interest “colour” and “size” with the similar product attribute “colour”, and identify the product 15 as product for recommendation 18 since for product 15 the sentiment for attribute “colour” is positive.

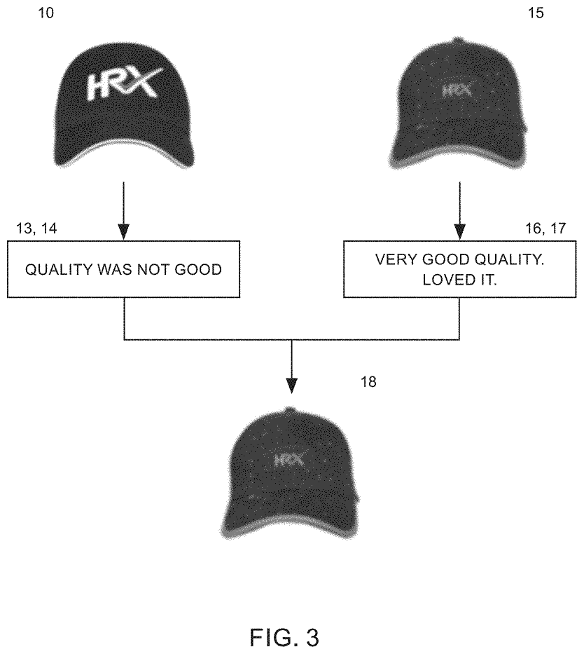

The attribute comparison module 110 is further configured to identify one or more product attributes of interest 13 having a corresponding negative sentiment 14. The attribute comparison module 110 is further configured to compare the identified product attributes of interest with the one or more similar product attributes 16 and their corresponding sentiment 17. The attribute comparison module 110 is furthermore configured to identify the at least one product for recommendation 18 if the at least one product has a positive sentiment corresponding to the one or more identified product attributes of interest 13. FIG. 3 illustrates an embodiment, wherein the attribute comparison module 110 is configured to identify an attribute of interest, such as, “quality” having a negative sentiment. The attribute comparison module 110 is further configured to compare the attribute “quality” with product attributes for similar products and identify at least one product for recommendation 18 that has a positive sentiment corresponding to attribute “quality”, as shown in FIG. 3.

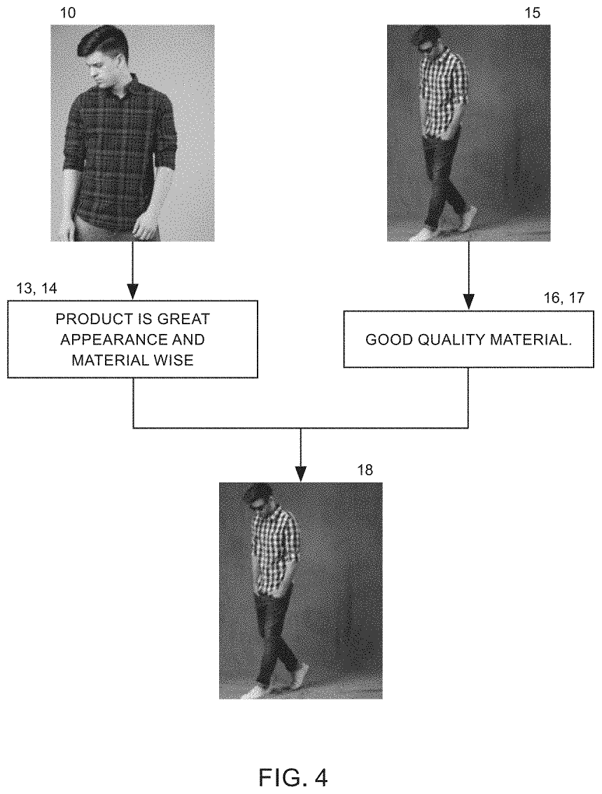

The attribute comparison module 110 is further configured to identify one or more product attributes of interest 13 having a corresponding positive sentiment 14. The attribute comparison module 110 is further configured to compare the identified product attributes of interest with the one or more similar product attributes 16 and their corresponding sentiment 17. The attribute comparison module 110 is furthermore configured to identify the at least one product for recommendation 18 if the at least one product has a positive sentiment corresponding to the one or more identified product attributes of interest 13. FIG. 4 illustrates an embodiment, wherein the attribute comparison module 110 is configured to identify an attribute of interest, such as, “material” having a positive sentiment. The attribute comparison module 110 is further configured to compare the attribute “material” with product attributes for similar products and identify at least one product for recommendation 18 that also has a positive sentiment corresponding to attribute “material”, as shown in FIG. 4.

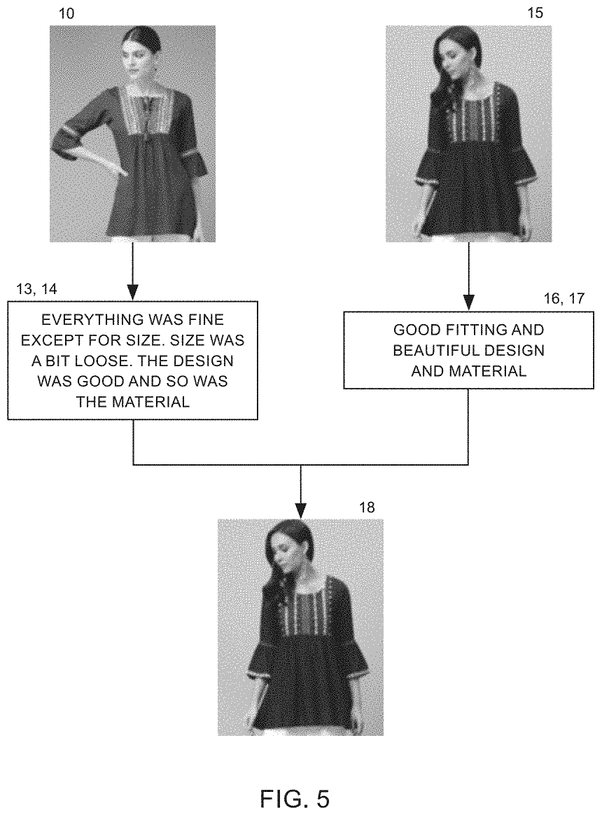

The attribute comparison module 110 is further configured to identify a plurality of product attributes of interest 13 having one or more corresponding positive or negative sentiments 14. The attribute comparison module 110 is further configured to compare the identified plurality of product attributes of interest 13 with the one or more similar product attributes 16 and their corresponding sentiment 17. The attribute comparison module 110 is furthermore configured to identify the at least one product for recommendation 18 if the at least one product has positive sentiments corresponding to the plurality of product attributes of interest 13. FIG. 5 illustrates an embodiment, wherein the attribute comparison module 110 is configured to identify a plurality of attributes of interest, such as, “size” having a negative sentiment, and “design” and “material” having positive sentiments. The attribute comparison module 110 is further configured to compare the attribute “size” with product attributes for similar products and identify at least one product for recommendation 18 that has positive sentiments corresponding to attributes “size”, “design”, and “material”, as shown in FIG. 5.

The product recommender 112 is communicatively coupled with the attribute comparison module 110, and configured to recommend to the customer the at least one identified product 18. In some embodiments, the attribute comparison module 110 is further configured to generate a score for each identified product for recommendation, and the product recommender 112 is configured to present a list of recommended products to the customer by ranking them based on their corresponding scores.

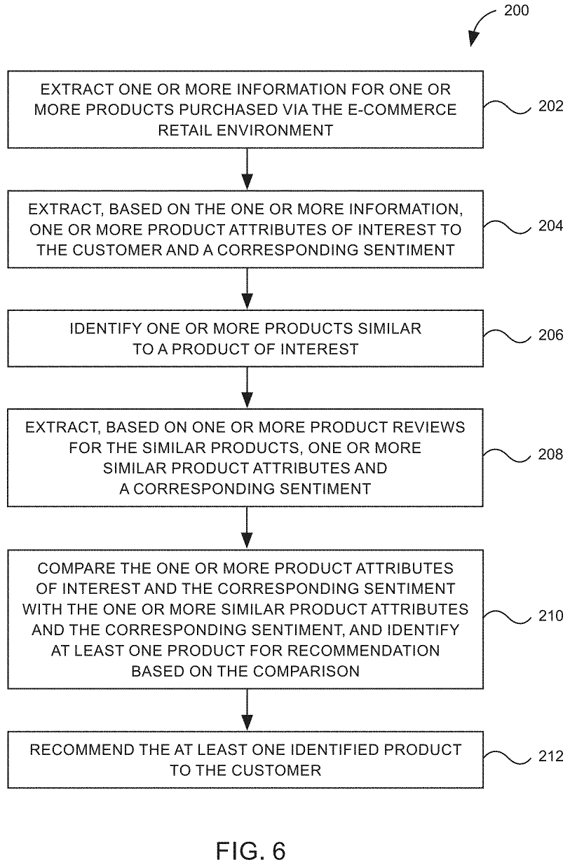

The manner of implementation of the system 100 of FIG. 1 is described below in FIG. 6.

FIG. 6 is a flowchart illustrating a method 200 for generating product recommendations for a customer in an e-commerce retail environment, The method 200 may be implemented using the systems of FIG. 1, according to some aspects of the present description. Each step of the method 200 is described in detail below.

The method 200 includes, at step 202, extracting one or more information for one or more products purchased via the e-commerce retail environment. In some embodiments, the one or more products are products purchased via the e-commerce retail environment by the customer for whom the recommendation is being generated. In some embodiments, the one or more products 10 are products purchased via the e-commerce retail environment by a customer different from the customer for whom the recommendation is being generated. The one or more products may belong to the same product categories, styles, or brands, or may belong to different product categories, styles, or brands as the product for which the recommendation is being generated.

The one or more information includes one or more product reviews for one or more products purchased via the e-commerce retail environment by the customer, one or more upvotes or downvotes submitted by the customer for product reviews on the e-commerce retail environment, one or more interactions with a product or with corresponding attributes by the customer on the e-commerce retail environment, or combinations thereof.

In one embodiment, the one or more information includes one or more product reviews for one or more products purchased via the e-commerce retail environment by the customer. In such embodiments, the step 202 includes extracting the one or more product reviews based on historical purchase data of the customer.

In some embodiments, the customer may be new or may not have submitted any reviews for products purchased via the e-commerce retail environment. In some such embodiments, the one or more information may include one or more interactions with a product or with corresponding attributes by the customer on the e-commerce retail environment. Further, in some such embodiments, the one or more information may include one or more upvotes or downvotes submitted by the customer for product reviews submitted by another customer on the e-commerce retail environment. In such embodiments, the step 202 may include extracting the one or more information corresponding to the product and/or attribute interactions by the customer or upvotes/downvotes submitted by the customer on the e-commerce retail environment.

Furthermore, in some such embodiments, the one or more information may include one or more product reviews submitted by another customer having a similar purchase profile as the current customer or by another customer having a similar geo-location as the current customer. In such embodiments, the step 202 may include extracting the one or more information from one or more products purchased via the e-commerce retail environment by a customer different from the customer for whom the recommendation is being generated.

At step 204, the method 200 includes extracting, based on the one or more information, one or more product attributes of interest to the customer, and a corresponding sentiment. The term “product attribute of interest” has been defined herein earlier. The products attributes of interest may be extracted from one or more product reviews for one or more products purchased via the e-commerce retail environment by the customer, from one or more upvotes or downvotes submitted by the customer for product reviews on the e-commerce retail environment, from one or more interactions with a product or with corresponding attributes by the customer on the e-commerce retail environment, or from combinations thereof.

Step 204 includes extracting the one or more product attributes of interest and a corresponding sentiment using machine learning models. Step 204 further includes storing the product information along with the extracted attributes of interest and corresponding sentiment.

At step 206, the method 200 includes identifying one or more products similar to a product of interest. In some embodiments, the product of interest may be determined based on the one or more information extracted, as described herein earlier. In some other embodiments, the product of interest may be determined based on a current search for a product by the customer, or, alternatively, previous search history, browsing history, product wish list added by the customer on the e-commerce retail environment.

The step 206 further includes identifying the one or more similar products based on the one or more product attributes of interest and/or an image of the product of interest. In some embodiments, the step 206 includes identifying the one or more similar products based on low-dimensional representations of the products derived using deep learning model corresponding to one or more products of interest. Step 206 may further include extracting one or more product reviews for the identified similar products.

The method 200 further includes, at step 208, extracting, based on one or more product reviews for the similar products, one or more similar product attributes and a corresponding sentiment;

At step 210, the method 200 includes comparing the one or more product attributes of interest and the corresponding sentiment with the one or more similar product attributes and the corresponding sentiment and identifying at least one product for recommendation from the one or more similar products based on the comparison, as described herein earlier with reference to FIG. 0.2.

In some embodiments, step 210 further includes identifying one or more product attributes of interest having a corresponding negative sentiment; comparing the identified product attributes of interest with the one or more similar product attributes and their corresponding sentiments; and identifying the at least one product for recommendation if the at least one product has a positive sentiment corresponding to the one or more identified product attributes of interest.

In some embodiments, step 210 further includes identifying one or more product attributes of interest having a corresponding positive sentiment; comparing the identified product attributes of interest with the one or more similar product attributes and their corresponding sentiments; and identifying the at least one product for recommendation if the at least one product also has a positive sentiment corresponding to the one or more identified product attributes of interest.

In some embodiments, step 210 further includes identifying a plurality of product attributes of interest having one or more corresponding positive or negative sentiments; comparing the identified plurality of product attributes of interest with a plurality of similar product attributes and their corresponding sentiments; and identifying the at least one product for recommendation if the at least one product has positive sentiments corresponding to the plurality of product attributes of interest.

The method further includes, at step 212, recommending the at least one identified product to the customer. In some embodiments, the method further includes generating a score for each identified product for recommendation, and presenting a list of recommended products to the customer by ranking them based on their corresponding scores.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

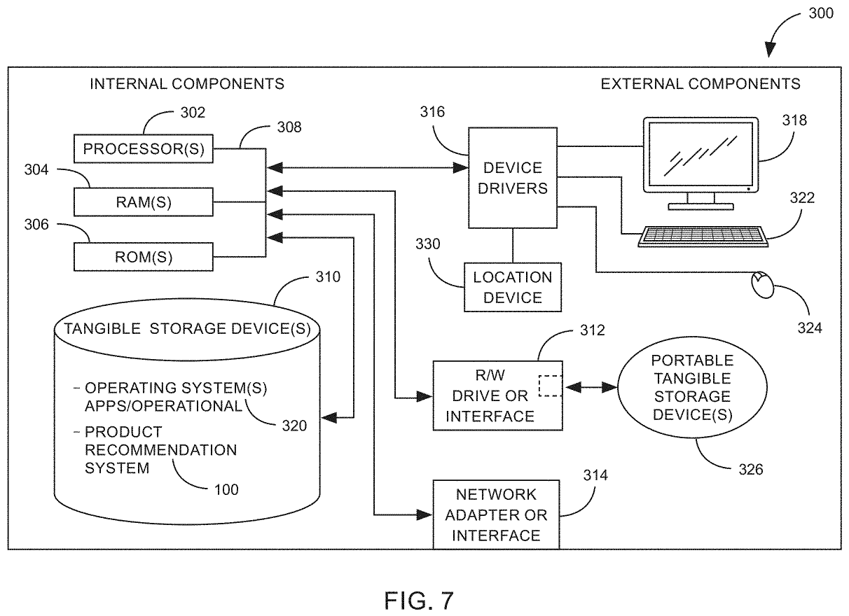

One example of a computing system 300 is described below in FIG. 7. The computing system 300 includes one or more processor 302, one or more computer-readable RAMs 304 and one or more computer-readable ROMs 306 on one or more buses 308. Further, the computer system 308 includes a tangible storage device 310 that may be used to execute operating systems 320 and product recommendation system 100. Both, the operating system 320 and the product recommendation system 100 are executed by processor 302 via one or more respective RAMs 303 (which typically includes cache memory). The execution of the operating system 320 and/or product recommendation system 100 by the processor 302, configures the processor 302 as a special-purpose processor configured to carry out the functionalities of the operation system 320 and/or the product recommendation system 100, as described above.

Examples of storage devices 310 include semiconductor storage devices such as ROM 503, EPROM, flash memory or any other computer-readable tangible storage device that may store a computer program and digital information.

Computing system 300 also includes a R/W drive or interface 312 to read from and write to one or more portable computer-readable tangible storage devices 326 such as a CD-ROM, DVD, memory stick or semiconductor storage device. Further, network adapters or interfaces 314 such as a TCP/IP adapter cards, wireless Wi-Fi interface cards, or 3G or 3G wireless interface cards or other wired or wireless communication links are also included in the computing system 300.

In one example embodiment, the product recommendation system 100 may be stored in tangible storage device 310 and may be downloaded from an external computer via a network (for example, the Internet, a local area network, or another wide area network) and network adapter or interface 314.

Computing system 300 further includes device drivers 316 to interface with input and output devices. The input and output devices may include a computer display monitor 318, a keyboard 322, a keypad, a touch screen, a computer mouse 324, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for generating product recommendations for a customer in an e-commerce retail environment, the system comprising:
a data module configured to extract one or more information for one or more products purchased via the e-commerce retail environment;
a first attribute extraction module configured to extract, based on the one or more information, one or more product attributes of interest to the customer and a corresponding sentiment;
a product identification module configured to identify one or more products similar to a product of interest;
a second attribute extraction module configured to extract, based on one or more product reviews for the similar products, one or more similar product attributes, and a corresponding sentiment;
an attribute comparison module configured to compare the one or more product attributes of interest and the corresponding sentiment with the one or more similar product attributes and the corresponding sentiment, and identify at least one product for recommendation from the one or more similar products based on the comparison; and
a product recommender configured to recommend to the customer the at least one identified product.

2. The system of claim 1, wherein the one or more information comprises one or more product reviews for one or more products purchased via the e-commerce retail environment by the customer, one or more upvotes or downvotes submitted by the customer for product reviews on the e-commerce retail environment, one or more interactions with a product or with corresponding attributes by the customer on the e-commerce retail environment, or combinations thereof.

3. The system of claim 2, wherein the one or more information comprises one or more product reviews for one or more products purchased via the e-commerce retail environment by the customer, and the data module is configured to extract the one or more product reviews based on historical purchase data of the customer.

4. The system of claim 1, wherein the one or more information comprises one or more product reviews submitted by another customer having a similar purchase profile as the current customer or by another customer having a similar geo-location as the current customer.

5. The system of claim 1, wherein the attribute comparison module is further configured to:
identify one or more product attributes of interest having a corresponding negative sentiment;
compare the identified product attributes of interest with the one or more similar product attributes and their corresponding sentiments; and
identify the at least one product for recommendation if the at least one product has a positive sentiment corresponding to the one or more identified product attributes of interest.

6. The system of claim 2, wherein the attribute comparison module is further configured to:
identify one or more product attributes of interest having a corresponding positive sentiment;
compare the identified product attributes of interest with the one or more similar product attributes and their corresponding sentiments; and
identify the at least one product for recommendation if the at least one product also has a positive sentiment corresponding to the one or more identified product attributes of interest.

7. The system of claim 1, wherein the attribute comparison module is further configured to:
identify a plurality of product attributes of interest having one or more corresponding positive or negative sentiments;
compare the identified plurality of product attributes of interest with a plurality of similar product attributes and their corresponding sentiments; and
identify the at least one product for recommendation if the at least one product has positive sentiments corresponding to the plurality of product attributes of interest.

8. The system of claim 1, wherein the attribute comparison module is further configured to identify the at least one product for recommendation from a product category that is different from a product category of the product of interest.

9. The system of claim 1, wherein the attribute comparison module is further configured to generate a score for each identified product for recommendation, and the product recommender is configured to present a list of recommended products to the customer by ranking them based on their corresponding scores.

10. The system of claim 1, wherein the product identification module is configured to identify the one or more similar products based on the one or more product attributes of interest and/or an image of the product of interest.

11. A method for generating product recommendations for a customer in an e-commerce retail environment, the method comprising:
extracting one or more information for one or more products purchased via the e-commerce retail environment;
extracting, based on the one or more information, one or more product attributes of interest to the customer and a corresponding sentiment;
identifying one or more products similar to a product of interest;
extracting, based on one or more product reviews for the similar products, one or more similar product attributes, and a corresponding sentiment;
comparing the one or more product attributes of interest and the corresponding sentiment with the one or more similar product attributes and the corresponding sentiment, and identifying at least one product for recommendation from the one or more similar products based on the comparison; and
recommending the at least one identified product to the customer.

12. The method of claim 11, wherein the one or more information comprises one or more product reviews for one or more products purchased via the e-commerce retail environment by the customer, one or more upvotes or downvotes submitted by the customer for product reviews on the e-commerce retail environment, one or more interactions with a product or with corresponding attributes by the customer on the e-commerce retail environment, or combinations thereof.

13. The method of claim 12, wherein the one or more information comprises one or more product reviews for one or more products purchased via the e-commerce retail environment by the customer, and the method comprises extracting the one or more product reviews based on historical purchase data of the customer.

14. The system of claim 11, wherein the one or more information comprises one or more product reviews submitted by another customer having a similar purchase profile as the current customer or by another customer having a similar geo-location as the current customer.

15. The method of claim 11, further comprising:
identifying one or more product attributes of interest having a corresponding negative sentiment;
comparing the identified product attributes of interest with the one or more similar product attributes and their corresponding sentiments; and
identifying the at least one product for recommendation if the at least one product has a positive sentiment corresponding to the one or more identified product attributes of interest.

16. The method of claim 11, further comprising:
identifying one or more product attributes of interest having a corresponding positive sentiment;
comparing the identified product attributes of interest with the one or more similar product attributes and their corresponding sentiments; and
identifying the at least one product for recommendation if the at least one product also has a positive sentiment corresponding to the one or more identified product attributes of interest.

17. The method of claim 11, further comprising:
identifying a plurality of product attributes of interest having one or more corresponding positive or negative sentiments;
comparing the identified plurality of product attributes of interest with a plurality of similar product attributes and their corresponding sentiments; and
identifying the at least one product for recommendation if the at least one product has positive sentiments corresponding to the plurality of product attributes of interest.

18. The method of claim 11, further comprising identifying the at least one product for recommendation from a product category that is different from a product category of the product of interest.

19. The method of claim 11, further comprising generating a score for each identified product for recommendation, and presenting a list of recommended products to the customer by ranking them based on their corresponding scores.

20. The method of claim 11, wherein the step of identifying the one or more similar products is based on the one or more product attributes of interest and/or an image of the product of interest.
